(19) United States
(12) Patent Application Publication
(10) Pub. No.: US 2007/0061989 A1
(43) Pub. Date: Mar. 22, 2007

(54) Adjustable concrete step tool

(76) Inventor: Robert Kalbach, Downingtown, PA (US)

Correspondence Address: Invent This! Inc.;The Law Office of Anthony R. Carlis, Suite 1D, 110 Hopewell Road, Downingtown, PA, 19335, US

(21) Appl. No.: 11/231,007

(22) Filed: Sep. 20, 2005

(51) Int. Cl. B05C 17/10

(52) U.S. Cl. 15/235.8; 15/235.4; 15/235.7

(57) ABSTRACT

The present invention is directed to a tool for troweling masonry steps which employs a convenient arrangement for swiftly positioning the trowel blade with a slight and easily repeatable consistent slope. To ensure uniformity, the present invention has an adjustable member which rides along the form of the step immediately above the one being trowled allowing an easily reproducible slope. In a preferred embodiment, a calibrated bubble level is included in the handle of the trowel which permits the stair finisher an indication of the angle of the slope he is producing.

### BACKGROUND OF THE INVENTION

Frame poured masonry steps need to be troweled with a slight downward slope. For example, as a person were to normally go up a set of stairs, the area under his or her toes would be slightly higher that the area under his or her heel. The slope permits water to run off each step to the step or landing beneath it. This is especially important when the steps are located outside and the steps are exposed to rain and snow. In the past, the slope was determined by a cement finisher, who is usually a skilled craftsman who set the slope in the cement or concrete just using his skills. The end result was entirely dependent upon the skill and attention devoted to the job by the craftsmen using his conventional trowel. To obtain satisfactory results, the cement finisher was required to call upon his considerable skill and had to pay vigilant attention using an appreciable amount of his time.

Stairwell management is a rapidly growing concern due to rising insurance costs, an aging population, more demanding local and federal regulations, a litigious environment and a commitment to provide a safe environment for building occupants. A major liability insurance provider indicated that of the top ten leading causes of disabling workplace injuries in 1999, slip/falls accounted for nearly 21% of the total direct costs incurred or nearly $8 billion. Of this amount, approximately $3.5 billion was incurred as a result of falls to lower levels. The direct costs include medical and Workers' Compensation payments. Indirect costs for lost productivity, overtime, administrative and legal fees, were estimated to be two to five dollars for each dollar of direct costs.

### SUMMARY OF THE INVENTION

The present invention is directed to a tool for troweling masonry steps which employs a convenient arrangement for swiftly positioning the trowel blade with a slight and easily repeatable consistent slope. To ensure uniformity, the present invention has an adjustable member which rides along the form of the step immediately above the one being trowled allowing an easily reproducible slope. In a preferred embodiment, a calibrated bubble level is included in the handle of the trowel which permits the stair finisher an indication of the angle of the slope he is producing.

### BRIEF DESCRIPTION OF THE DRAWINGS

FIG. 1 is an overall perspective view of the present tool;

FIG. 2 is also a perspective view showing the tool in use on a poured masonry step;

FIG. 3 is an exploded view of the tool showing the rudimentary parts and their relationship to each other;

FIG. 4 illustrates an embodiment which has an adjustable thumb screw which adjust a bubble level permitting the user to adjust the troweling angle; and

FIG. 5 is a detailed view of the above embodiment showing the bubble adjusting mechanism.

### DETAILED DESCRIPTION OF THE PREFERRED EMBODIMENTS

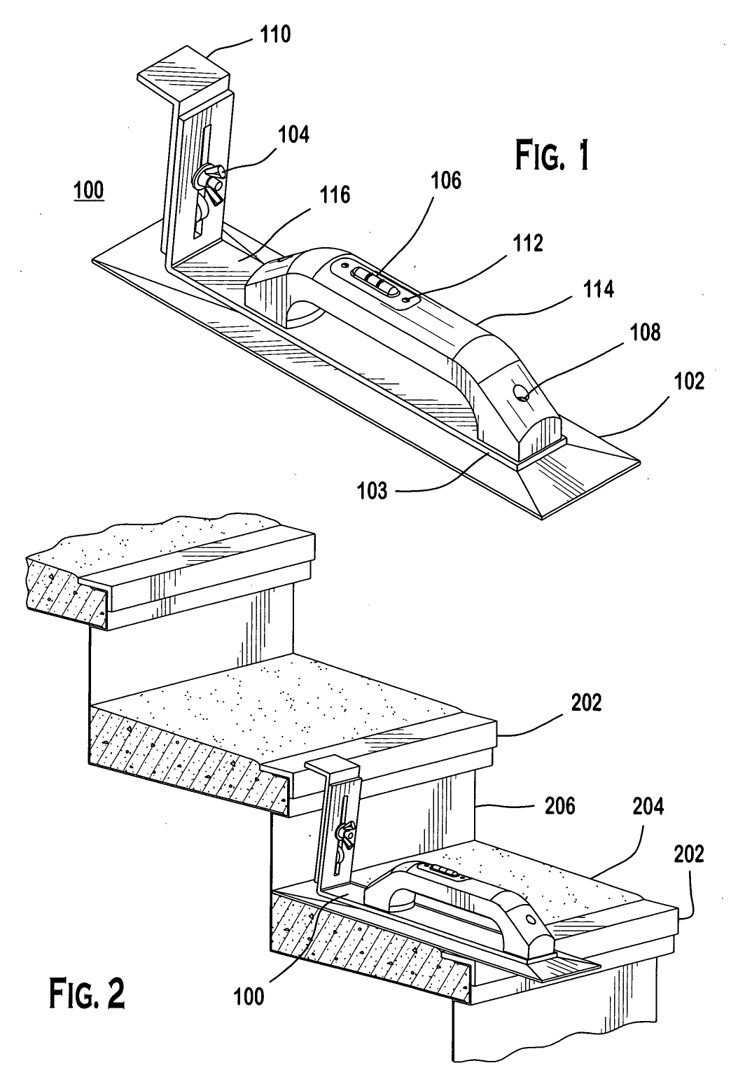

Referring first to FIGS. 1 and 3, the present tool 100 has a conventional elongated trowel blade 102 with a flat bottom face for contacting with the top of a masonry step before it has hardened. A handle 114 is attached first to a reference member 116 and then to the trowel blade 103 via screws 108 and extends above the elongated trowel blade 102 longitudinally in accordance to the direction in which the blade is elongated. The reference member 116 is “sandwiched” between the trowel blade 103 and the handle 114 and is connected to an adjustable reference member 110 which engages and rides over a step riser front form of the next higher step. In the present embodiment, the adjustable reference member 110 has been formed in an upside down “L” shape whereby the protruding cantilever of the “L” segment slides over the step riser form of the next higher step. A bubble level 106 is attached to handle 114 via easily replaceable attachment screws 112.

In alternative embodiments, said screws 108 and said easily replaceable attachment screws 112 can be replaced by any means which attaches the pieces together. For example, the screws could be rivets, spot welds or the present invention could be produced as one piece via an injection mold system. Also, in an alternative embodiment, the reference member 116 and conventional elongated trowel blade 102 can be formed as one piece.

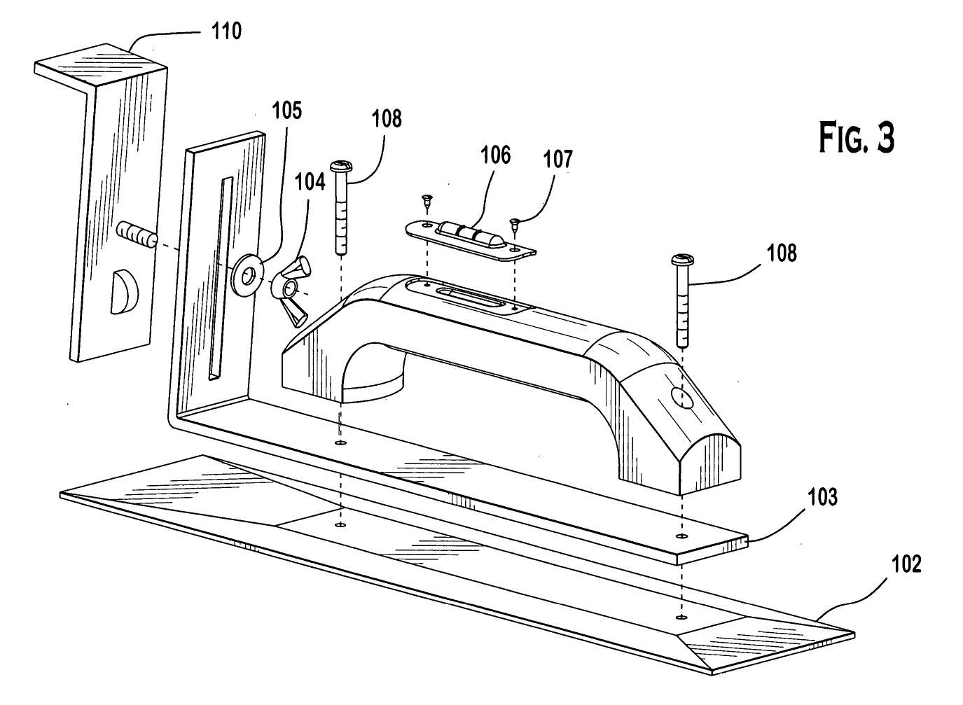

FIG. 2. illustrates the present invention on a masonry stair form showing a foot heel area section 202, a poured material finishing area 204 and a foot toe area section 206. The adjustable reference member 110 rides on the foot heel area section 202 of the stair immediately above the one that is being worked upon. For example, the poured material finishing area 204 can be cement and the angle or slope of the poured material finishing area 204 is set on upon the present invention permitting the foot toe area section 206 to be finished higher than the area near the foot heel area section 202. This permits water, ice, snow and other substances to travel off the steps via gravity (drain) and thus helping keeping the stairs clear and safely passable.

As mentioned above, it is important that each step drain itself to the step below itself. Therefore, the user of the present invention would set up the present invention by means of the reference bubble level 106. For example, the user would employ the bubble level 106 to identify when the tool is level or at any desired angle. The reference bubble level 106 is graduated emphasizing the various slope angles available to the stair finisher. The user would simply choose the correct slope for that particular job he or she is working on and set the present invention to the slope.

In yet another embodiment, the adjustable reference member 110 would have a wheel affixed to it permitting the trowel to “roll” across the foot heel area section 202 of the stair immediately above the one that is being worked upon instead of sliding in it.

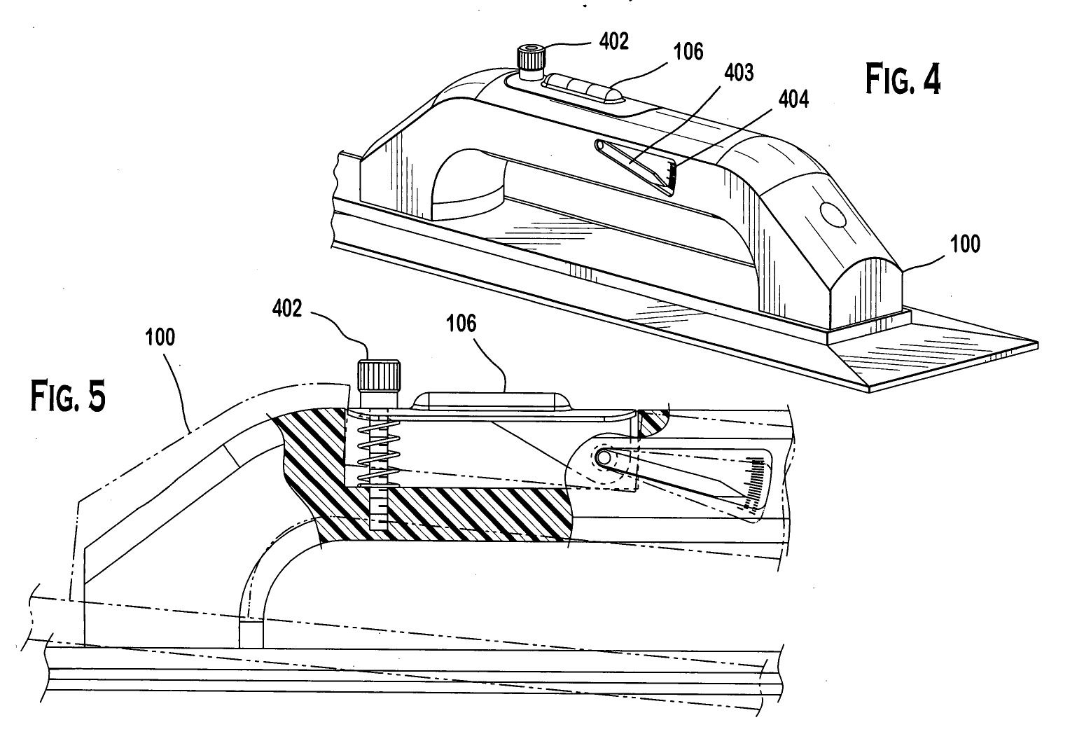

Now referring to FIGS. 4 and 5, an alternative to the present invention has a thumb screw 402 to raise and lower the bubble level 106 within the handle. The bubble level 106 is also connected to an angle indicating arm 403, is also on the handle. An angle indicating scale 404 is also illustrated and is part of the handle.

To set up the desired slope using this embodiment, the thumbscrew 402 is utilized to adjust the slope while monitoring the angle indicating arm 403 against the angle indicating scale 404. This embodiment permits the present invention to obtain a finer resolution of slope.

It should be understood that the disclosed embodiments of the present invention are not limited in its application to the details of the particular arrangements shown, since the invention is capable of other embodiments. Also, the terminology used herein is for the purpose of description and not of any limitation.

What is claimed is:

1. A tool for troweling masonry steps to a desired angle comprising:
a trowel blade for troweling the surface of a step;
a substantially rigid support handle with a bubble level, wherein said substantially rigid support handle has a bubble;
said handle extends out from said blade and is affixed to at least two ends of said trowel blade;
an affixed reference member attached to one end of said trowel blade and a corresponding adjustable reference member with an angled masonry form guide adjustably connected to said affixed reference member;
and means for releaseably locking said corresponding adjustable reference member to a selected position along said affixed reference member to produce a desired slope on said masonry steps.

2. A tool according to claim 1, wherein said corresponding adjustable reference member has a roller to roll on a masonry form of said masonry steps.

3. A tool according to claim 1, wherein said trowel blade is made from stainless steel, plastic or any other flat surface hard surface.

4. A tool according to claim 1, wherein the angle to which the trowel finishes the stairs can be set by a user via an adjustable screw which varies the angle between said substantially rigid support handle and said bubble level producing a consistent angled finished step.

5. A method for using a tool for troweling masonry steps comprising:
troweling the surface with an adjustable trowel which has a substantially rigid handle support extending up from said blade affixed to at least two ends of said trowel blade;
regulating said trowel angle by use of an affixed reference member attached to one end of said trowel blade and a corresponding adjustable reference member with an angled masonry form adjustably connected to said affixed reference member;
and means for releaseably locking said corresponding adjustable reference member to a selected position along the affixed reference member to produce a desired slope on masonry steps.

6. The method of claim 5 further comprising;
rolling said corresponding adjustable reference member across a stair form with an attached roller.

7. The method of claim 5 further comprising;
adjusting said angle of the trowel by a user via an adjustable screw which moves the bubble level and therefore changing a reference trowel level.
